(19) United States
(12) Patent Application Publication
(10) Pub. No.: US 2022/0391996 A1
(43) Pub. Date: Dec. 8, 2022

(54) TECHNIQUES FOR COORDINATING AND MANAGING VOLUNTARY BLOOD DONORS WITH LOCAL AND GLOBAL PARTNERS

(71) Applicant: Meta Platforms, Inc., Menlo Park, CA (US)

(72) Inventors: Yizhaq EZRA, Bend, OR (US); Robert Kang JIN, Portola Valley, CA (US); Hema BUDARAJU, Cupertino, CA (US); Arti Arvind KULKARNI, Santa Clara, CA (US); Peter Cunningham CLASEN, Alameda, CA (US); Stephen HARRELL, Oakland, CA (US); Puneet GUPTA, Union City, CA (US); Boyan LIN, Redwood City, CA (US); Frederick WIDJAJA, Jakarta Barat (ID); Zachary Alec CHAUVIN, San Francisco, CA (US); Tori Bea SEIDENSTEIN, Cabin John, MD (US); Mahima GUPTA, Santa Clara, CA (US); Chang SU, Mountain View, CA (US); Kaushik SETHURAMAN, Seattle, WA (US); Jasmine I'esha Charmayne LAWRENCE, San Francisco, CA (US); Nicholas William INZUCCHI, San Francisco, CA (US); Charlie HART, San Francisco, CA (US); Aubrey BACH, Seattle, WA (US); Neil DEXTER, San Francisco, CA (US); Patrick Yang XU, El Cerrito, CA (US); Zanique Libby ALBERT, San Francisco, CA (US)

(73) Assignee: Meta Platforms, Inc., Menlo Park, CA (US)

(21) Appl. No.: 17/747,604

(22) Filed: May 18, 2022

Related U.S. Application Data
(60) Provisional application No. 63/197,076, filed on Jun. 4, 2021.

(51) Int. Cl. G06Q 50/00; G06Q 30/02

(52) U.S. Cl. CPC G06Q 50/01; G06Q 30/0205

(57) ABSTRACT

According to examples, a system for coordinating and managing potential volunteers (i.e., volunteer blood donors) is disclosed. The system may include may include a processor and a memory storing instructions. The processor, when executing the instructions, may cause the system to receive partner data from one or more of a local partner and a global partner and determine a donation need based on the partner data. The processor may also cause the system to identify a pool of volunteer donors based on the donation need, build an online campaign to increase the pool of volunteer donors, and coordinate the pool of volunteer donors with the local or global partners based at least in part on a machine learning (ML) technique.

### PRIORITY

This patent application claims priority to U.S. Provisional Patent Application No. 63/197,076, entitled “Techniques for Coordinating and Managing Voluntary Blood Donors with Local and Global Partners,” filed on Jun. 4, 2021.

### TECHNICAL FIELD

This patent application relates generally to computer-based search and data management systems, and more specifically, to systems and methods for coordinating and managing voluntary blood donors with local and global partners.

### BACKGROUND

Advances in social media technologies coupled with mobile telecommunications are changing the lifestyles of people and how they look for directions, food, entertainment, and other goods and services. These technological advances may be used to provide encourage prosocial behavior, especially in the delivery of medical and emergency-related goods and services, such as blood donation.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1A illustrates a block diagram of a system for coordinating and managing voluntary blood donors with local and global partners, according to an example.

FIG. 1B illustrates a block diagram of a system environment for the system of FIG. 1A for coordinating and managing voluntary blood donors with local and global partners, according to an example.

FIGS. 2A-2B illustrate graphs illustrating change in donations when using a blood donation tool, according to an example.

FIGS. 2C-2E illustrate a screens of a blood donation tool via a user device, according to an example.

FIG. 2F illustrates a diagram of blood donation partners from a geographic area, according to an example.

FIGS. 2G-2J illustrate graphs illustrating average daily blood donations, according to an example.

FIG. 2K illustrates a graph illustrating placebo tests examining parallel pre-trends, according to an example.

FIGS. 2L-2P illustrate diagrams and graphs of a blood donation partners from two geographic areas, according to an example.

FIG. 2Q illustrates a diagram of a blood donation partners from two geographic areas with non-overlapping or overlapping radii, according to an example.

FIG. 2R illustrates a graph illustrating change in donations when using a blood donation tool, according to an example.

FIG. 3 illustrates a block diagram of a system for providing AI-based recommendations, according to an example.

FIG. 4 illustrates a block diagram of a computer system for providing recommendations using a search radius based on density, according to an example.

FIG. 5 illustrates a method for coordinating and managing voluntary blood donors with local and global partners, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on

As described above, technological advances in social networking and data management may be used to facilitate user-user interactions. They may also be used provide a platform to help and facilitate delivery of medical and emergency-related goods and services. For example, online social networks may be used to encourage behaviors that improve the health and well-being of society at an unprecedented scale.

In some examples, a blood donation tool may be provided using the techniques described herein. Some preliminary evidence has been obtained from to demonstrate that social networks may positively support public health by encouraging offline prosocial behavior at scale.

It should be appreciated that prosocial behavior, as defined herein, may refer to behavior with the intent to benefit others or humanity as a whole. Prosocial behavior, therefore, may be fundamental to any well-functioning society, and may include behaviors, such as helping, sharing, donating, cooperating, volunteering, and/or looking out for others' well-being. Such behaviors may be tied to economic value of counties, states, and/or countries. By connecting people to the causes they care about, lowering information costs, and enabling peer encouragement, social media platforms—together with various intelligent AI-based tools—may provide new avenues to increase and encourage prosocial behaviors at scale.

Although blood donation management and coordination examples are described throughout, it should be appreciated that examples outlined herein may be used for any number of scenarios where people are being connected to events or causes they care about. For example, social network platforms may have an impact on a disaster response ecosystem, for example, by assisting first responders during natural disasters and raising donations in times of emergency. Additionally, online social networks may also play an important role for people to support human rights and marginalized groups.

Blood donation, however, is a particularly difficult, yet essential prosocial behavior that is often critically undersupplied. Donating blood requires individuals to overcome a set of physical and logistic challenges (e.g., obtain transportation, allocate sufficient time for the procedure and recovery, and the physical and psychological discomfort associated with the procedure) to complete an act for which they often have no tangible evidence of benefit to others. Since blood cannot be synthesized or manufactured and has a limited shelf life, blood donations are a critical part of health-care delivery and society. For example, blood may be required for surgery, cancer treatment, burn and accident victims, genetic blood disorders, and/or complications during childbirth. There are some estimates, provided by the American Red Cross, for example, that purport that every two seconds someone in the U.S. needs blood. The World Health Organization (WHO) also state that without a system based on voluntary unpaid blood donations, no country can provide sufficient blood for all patients who require transfusion. Lack of voluntary blood donations is becoming an increasing problem all over the world.

The systems and methods described herein may provide a technique for coordinating, managing, and connecting voluntary blood donors with local and global partners. The systems and methods described herein may help connect people to the cause of blood donation, lowering information costs to help individuals identify opportunities (and criteria) to donate, and encouraging donors to take action.

The systems and methods described herein may include three key intervention components. The first may include a largescale, targeted awareness campaign, using social networks, to connected people and partners to the cause of blood donation. The second intervention component may include lowering information costs. This may include serving invitations in people's news feeds on social networking platforms. The third intervention component may include ways for blood banks or other partners to inspire donors and/or for donors to inspire each other, e.g., encourage prosocial behavior. These will be described in more detail below.

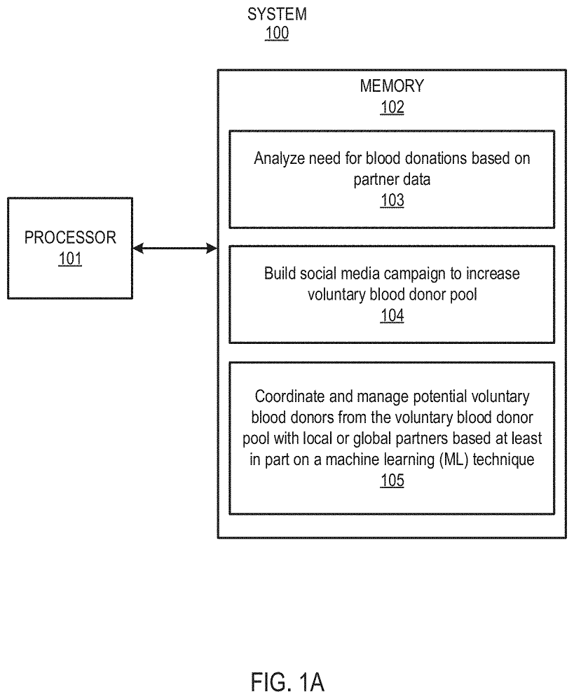

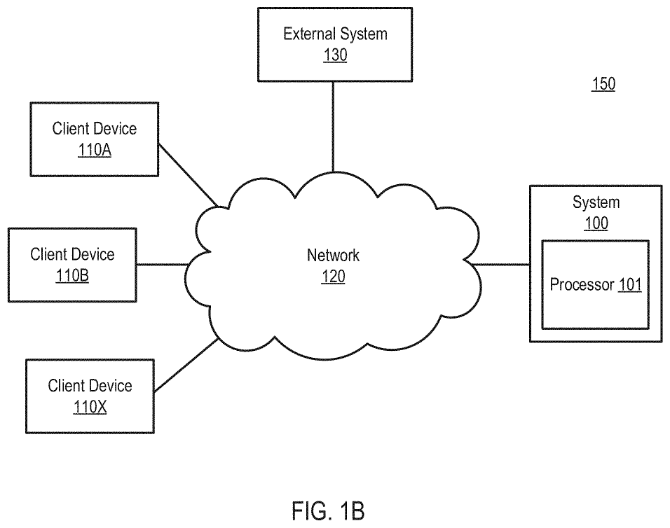

Reference is now made with respect to FIGS. 1A and 1B. FIG. 1A illustrates a block diagram of a system for coordinating and managing voluntary blood donors with local and global partners, according to an example. FIG. 1B illustrates a block diagram of a system environment for the system of FIG. 1A for coordinating and managing voluntary blood donors with local and global partners, according to an example. It should be appreciated that the system 100 depicted in FIGS. 1A-1B and/or the system environment 150 depicted in FIG. 1B may be examples. Thus, the system 100 and/or the system environment 150 may or may not include additional features and some of the features described herein may be removed and/or modified without departing from the scopes of the system 100 and/or the system environment 150 outlined herein.

As shown in FIG. 1B, the system environment 150 may include any number of client devices 110, shown as client devices 110A, 110B, and 110X, in which the variable “X” may represent an integer greater than one. The system environment 150 may also include a network 120, and an external system 130.

In operation, the system 100 may communicate with the client devices 110, the external system 130, and/or other network elements via the network 120. In some examples, the system 100 may receive or transmit data to/from the client devices 110, the external system 130, and/or other network elements in order to coordinate and manage voluntary blood donors with local and global partners. In some examples, the system 100 may be a social networking system, a content sharing network, an advertisement system, an online system, and/or any other system that facilitates any variety of data processing in personal, social, commercial, financial, and/or enterprise environments.

In some examples, the system 100 may include a processor 101 and a memory 102, as shown in FIG. 1A. The memory 102 may store instructions, which when executed by the processor 101, may cause the processor to analyze a need for blood donations based on partner data, build a social media campaign (or otherwise an online campaign) to increase voluntary blood donor pool, and coordinate and manage potential voluntary blood donors from the voluntary blood donor pool with local or global partners based at least in part on a machine learning (ML) technique.

As described in more detail below, to coordinate and manage potential voluntary blood donors from the voluntary blood donor pool with local or global partners, the processor 101, as instructed by machine-readable instructions stored in the memory 102, may use at least one machine learning (ML) technique. The machine learning (ML) technique may rely at any number of data inputs, such as partner data, user data, and use various ranking and/or weighting calculations to connect potential donors with partners in order to satisfy partner needs and/or improve prosocial behavior, as described in more detail herein. Applying artificial intelligence (AI) based machine learning (ML) technique may enable the system 100 to make recommendations that are more relevant, useful, and/or acceptable to the user or partner. For example, it may be determined, using a combination of ranking or weighting factors. Armed with this information, the systems and methods may present or recommend these potential partners for potential donors, and stimulate donor responsiveness, especially in the case of blood donations.

Accordingly, the system 100 may enable any number of client devices 110 communicatively coupled to the system 100 to search for any number of items. In this way, the client devices 110 may submit searches and/or receive search results or recommendations for any number of items, such as nearby blood banks, etc., to which she is interested without the redundancies or inefficiencies encountered by more traditional search systems that use an initial predetermined or fixed radius. Details of the system 100 and its operation within the system environment 150 will be described in more detail below.

It should be appreciated that the processor 101 may be a semiconductor-based microprocessor, a central processing unit (CPU), an application specific integrated circuit (ASIC), a field-programmable gate array (FPGA), and/or other suitable hardware device. In some examples, the memory 102 may have stored thereon machine-readable instructions 103-107 (which may also be termed computer-readable instructions) that the processor 101 may execute. The memory 102 may be an electronic, magnetic, optical, or other physical storage device that contains or stores executable instructions. The memory 102 may be, for example, Random Access memory (RAM), an Electrically Erasable Programmable Read-Only Memory (EEPROM), a storage device, an optical disc, and the like. The memory 102, which may also be referred to as a computer-readable storage medium, may be a non-transitory machine-readable storage medium, where the term “non-transitory” does not encompass transitory propagating signals.

Each of the client devices 110 may be a computing device that may transmit and/or receive data via the network 120. In this regard, each of the client devices 110 may be any device having computer functionality, such as a smartphone, a tablet, a laptop, a watch, a desktop, a server, or other computing device. In some examples, the client devices 110 may be mobile devices that are communicatively coupled to the network 120 and enabled to interact with various network elements over the network 120. In some examples, the client devices 110 may execute an application allowing a user of the client devices 110 to interact with various network elements on the network 120. For instance, the client devices 110 may receive data from user input, a database, a file, a web service, and/or via an application programming interface (API). Additionally, the client devices 110 may execute a browser or application to enable interaction between the client devices 110 and the system 100 (or external system 130, etc.) via the network 120. For example, a user may interact with a mobile application or a web application, executing via a browser, in order to initiate a search for an item or initiate a search query for an item via the network 120. In an example, the client devices 110 may interact with the system 100 through application programming interfaces (APIs) running on a native or remote operating systems of the client devices 110. In this example, the external system 130 may be a data source for items, maps, or other relevant data. Other various examples may also be provided.

Although one or more portions of the system 100 and/or external system 130 may reside at a network centric location, as shown, it should be appreciated that any data or functionality associated with the system 100, the external system 130, and/or other network element may also reside locally, in whole or in part, at the client devices 110, or at some other computing device communicatively coupled to the client devices 110.

The network 120 may be a local area network (LAN), wide area network (WAN), the Internet, a cellular network, a cable network, a satellite network, or other network that facilitates communication between the client devices 110, the external system 130, the system 100, and/or any other system, component, or device connected to the network 120. The network 120 may further include one, or any number, of the exemplary types of networks mentioned above operating as a stand-alone network or in cooperation with each other. For example, the network 120 may utilize one or more protocols of one or more clients or servers to which they are communicatively coupled. The network 120 may facilitate transmission of data according to a transmission protocol of any of the devices and/or systems in the network 120. Although the network 120 is depicted as a single network in FIG. 1B, it should be appreciated that in some examples, the network 120 may include a plurality of interconnected networks as well.

The external system 130 may be communicatively coupled to the network 120. In some examples, the external system 130 may host a third-party website, or any content or data source, that provides content or data to the client devices 110, and/or the system 100. In some examples, the external system 130 may be a data center with servers to store and/or provide information associated with searching for items. This may include information associated with items, such as maps, reviews, calendars, etc. In some examples, the external system 130 may also provide digital media content to the client devices 110, the system 100, and/or other network elements (not shown) in the system environment 150. In some examples, the external system 130 may include one or more application servers that host various applications for the client devices 110, the host systems 140, the system 100, and/or other network elements. Other various examples may also be provided.

A largescale, targeted awareness campaign, using social networks, to connect people and partners to the cause of blood donation may be achieved by using a robust social network system, as shown in FIGS. 1A-1B. A first intervention component may involve a social media driven campaign, for example, which may utilize some or all of the features of the system 100, among other things, to highlight benefits of donating blood to others and help construct a large-scale awareness campaign worked to build a large pool of interested individuals.

A second intervention component may include lowering information costs. Blood banks or other similar partner may elect to receive alerts to opted-in individuals located within a certain geographical radius (e.g., 10 miles) of their facility every so often via manual or automated alerts. These alerts may also be triggered by the local blood donation facility, but served by the social network hosted by the systems and methods described herein. Such dissemination of information via social networking channels, as well as AI-driven recommendations may, for example, may show a location of a nearest blood bank, indicate what blood type(s) the blood bank is looking for, provide logistical information like the blood donation center's hours, address, and telephone number, offer clear guidance on donation eligibility, and/or other information or recommendations.

The third intervention component may include ways for blood banks or other partners to inspire donors and/or for donors to inspire each other, e.g., encourage prosocial behavior. For example, feedback or other related information from blood banks, partners, donors to be included in social network delivery mechanisms may be used to help provide inspiration, testimonies, and/or stories, some of which may be impact others to do the same.

The systems and methods described herein may provide blood donation recommendations and increase pool of potential volunteer blood donors. For instance, the systems and methods may scan the density of users and/or partners within a location, and map each of the user and/or partner locations (e.g., to identify a pool of volunteers) as well. In some examples, the systems and methods described herein may use an items distribution based on item density or concentration of items over a particular area, as well as other factors, such as time, user preferences, and/or third-party data, to compute recommendations for the user or partners. In this way, the systems and methods may use this information to compute, connect, and facilitate partners (e.g., blood banks) with potential donors (e., blood donors), from start to finish. Furthermore, by leveraging AI or ML based learning techniques, additional social media based campaigns may help elevate prosocial behaviors and drive the pool of potential volunteers and more readily match them to partners in need. Overall, the systems and methods described herein may provide greater accuracy and efficiency, not to mention reducing processing load requirements, time, and/or resources. Moreover, such systems and methods may yield more relevant connections between users and partners, and in a more holistic fashion. These and other examples will be described in more detail herein.

It should also be appreciated that the systems and methods described herein may be particularly suited for coordinating and managing voluntary blood donors with local and global partners, but may also be used for any number of other types of events, good, or services. These may include, for example, music, art, culinary, entertainment, directions, digital media, housing, and/or other events, goods, or services. For instance, a searchable item, as used herein, may include, but are not limited to, any or all of these examples. Such items may also include any item associated with any number of online actions, advertisements, and/or financial transactions. These and other benefits will be apparent in the description provided herein.

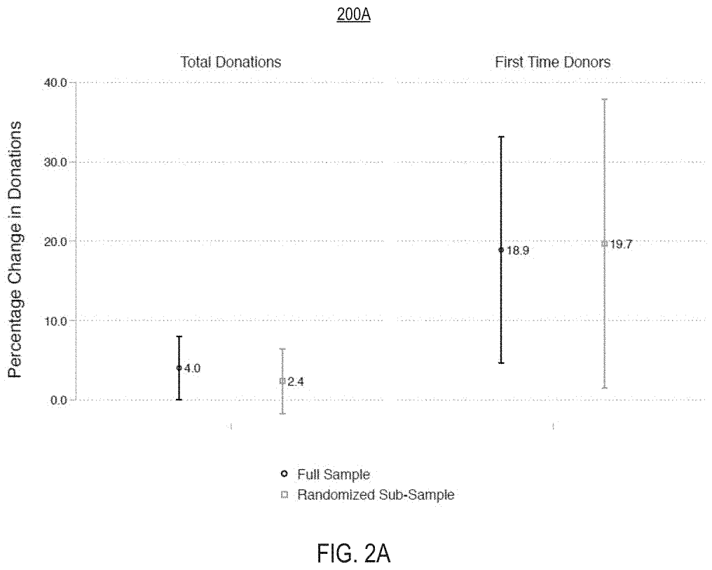

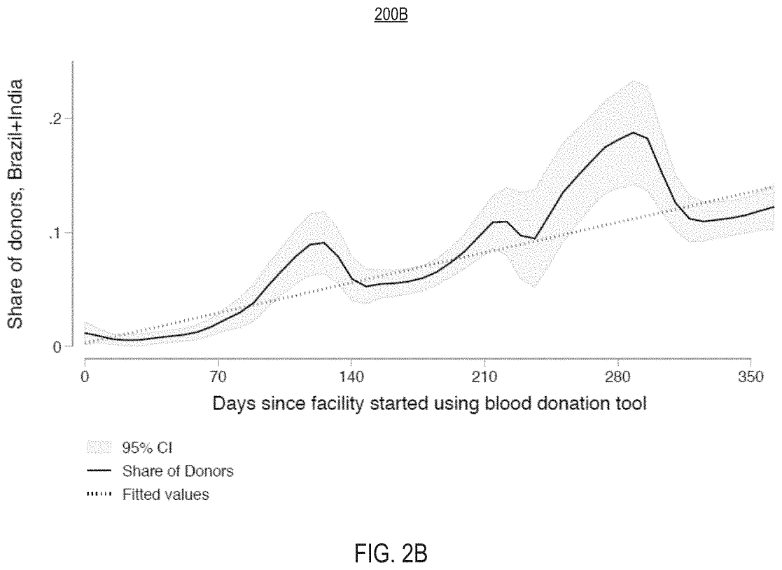

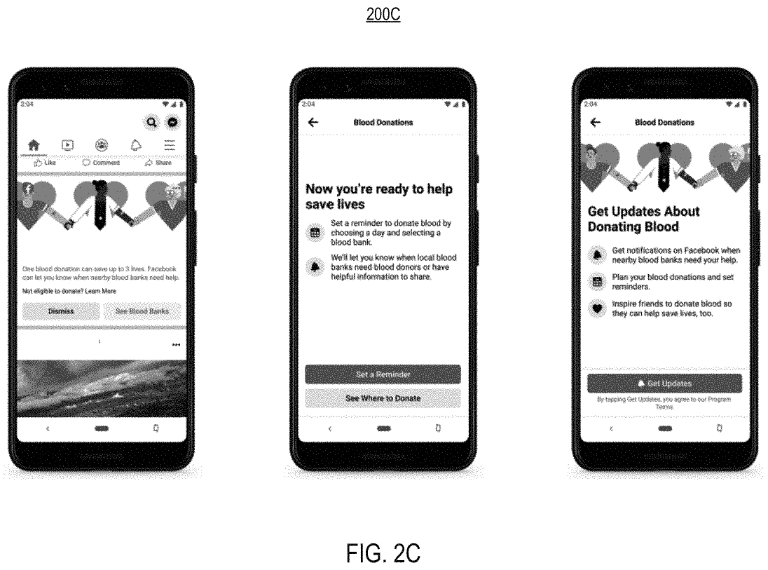

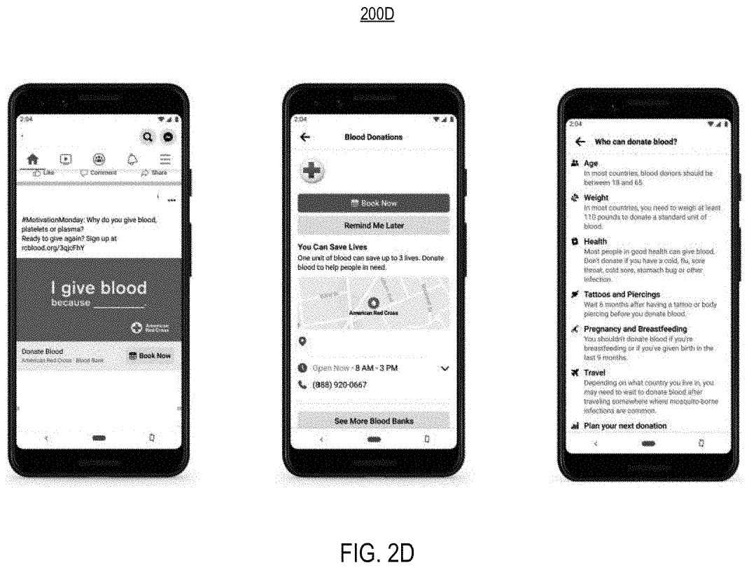

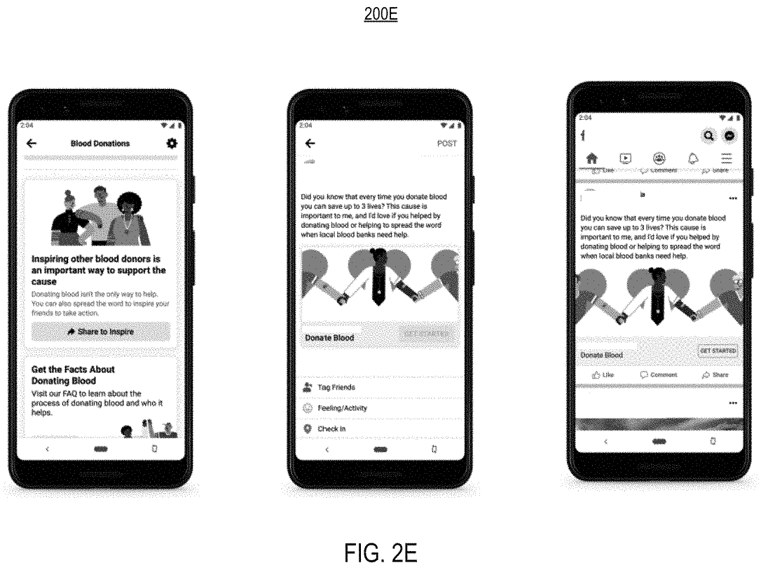

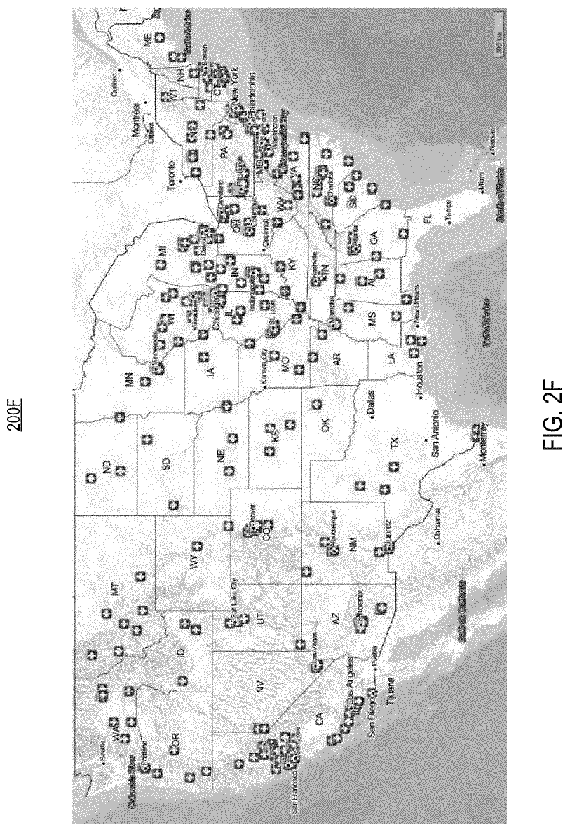

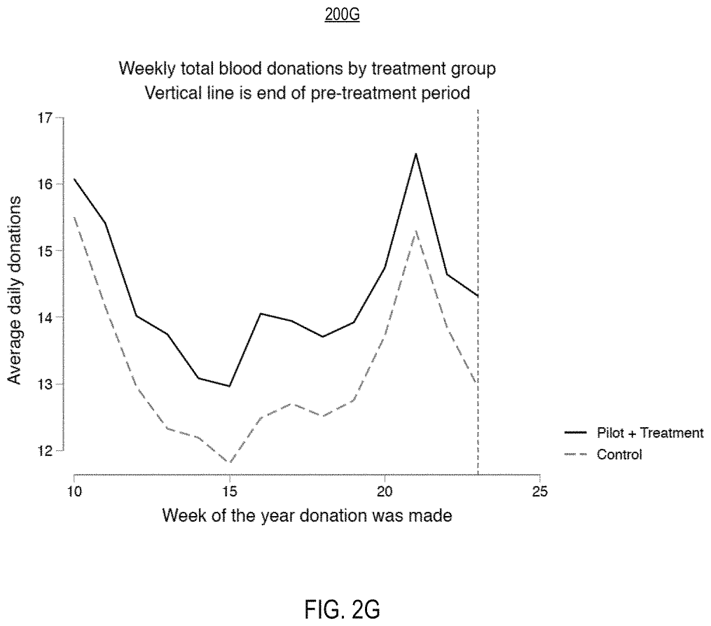

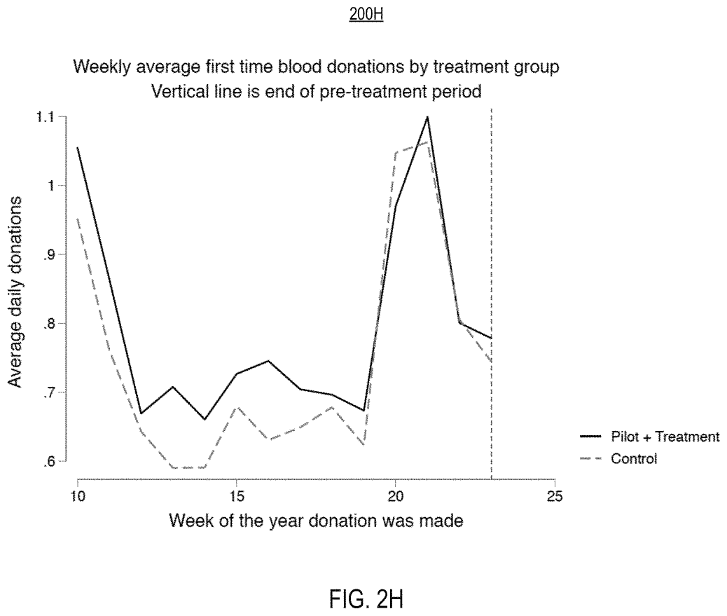

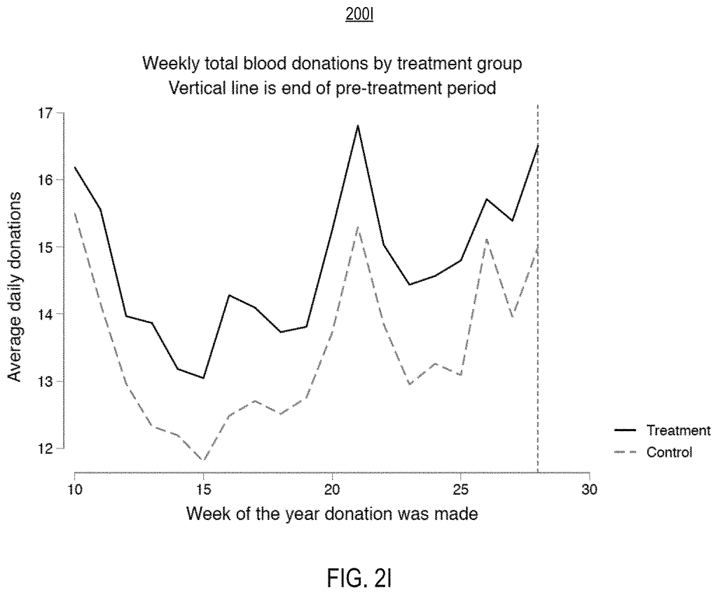

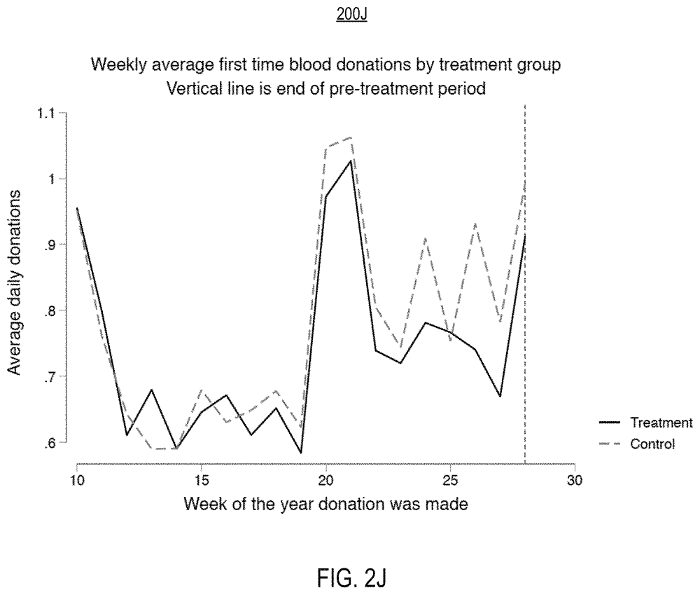

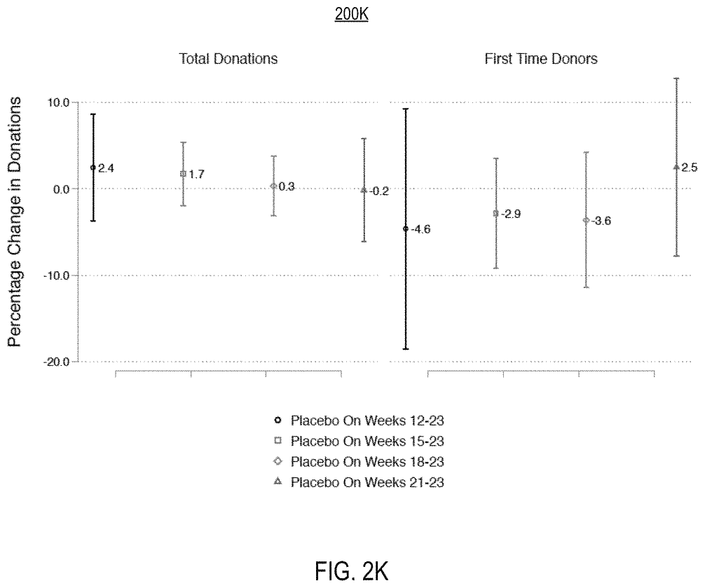

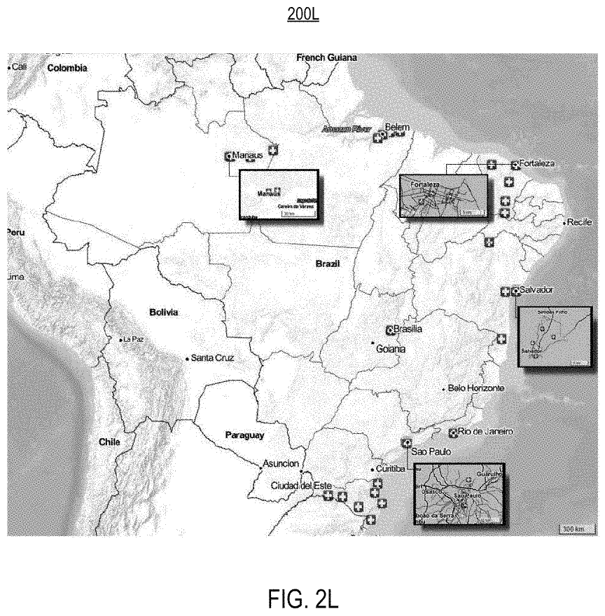

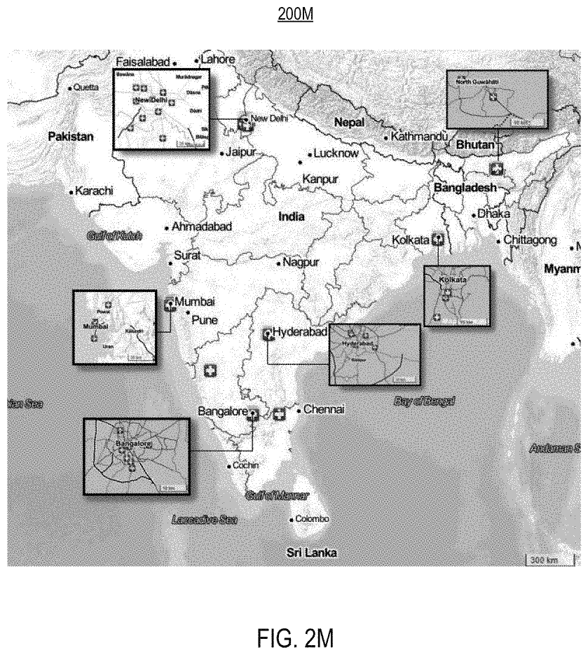

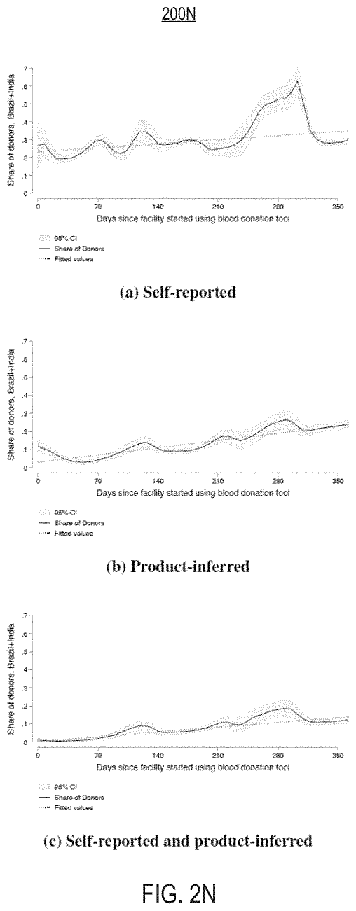

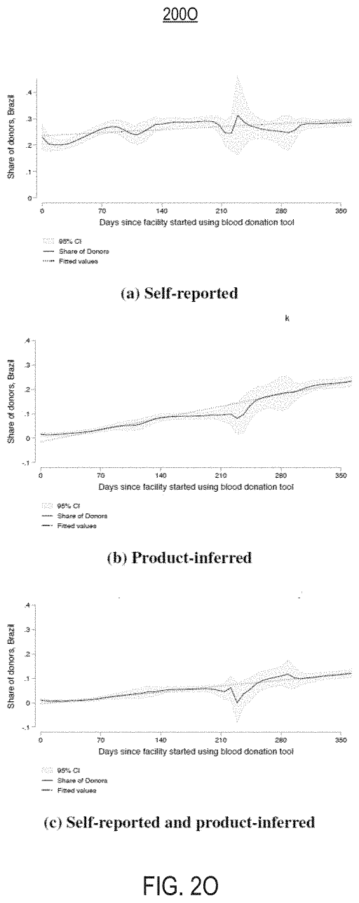

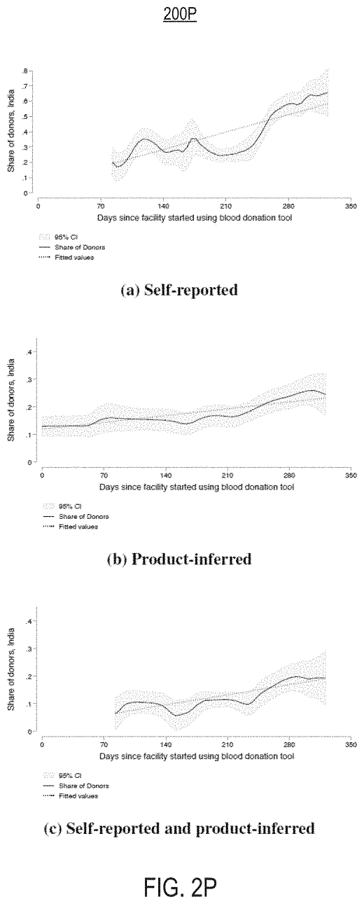

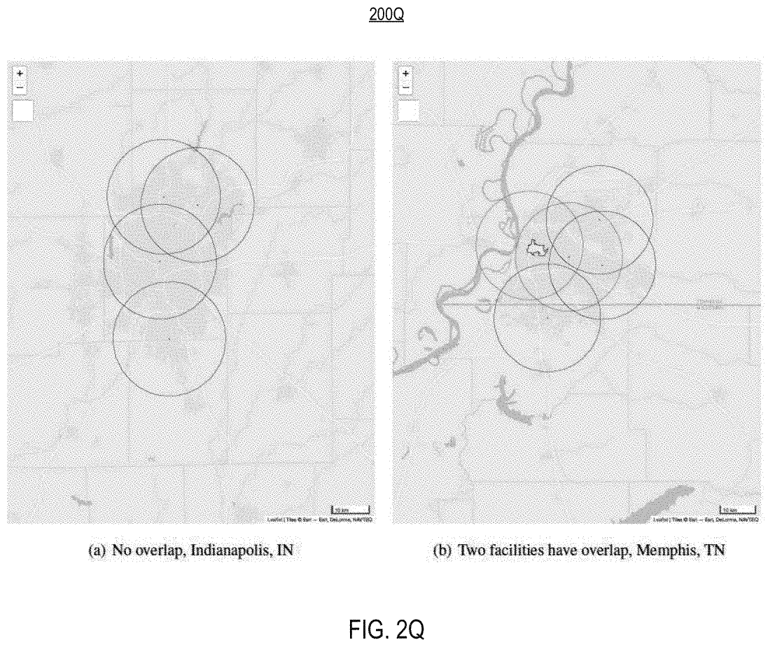

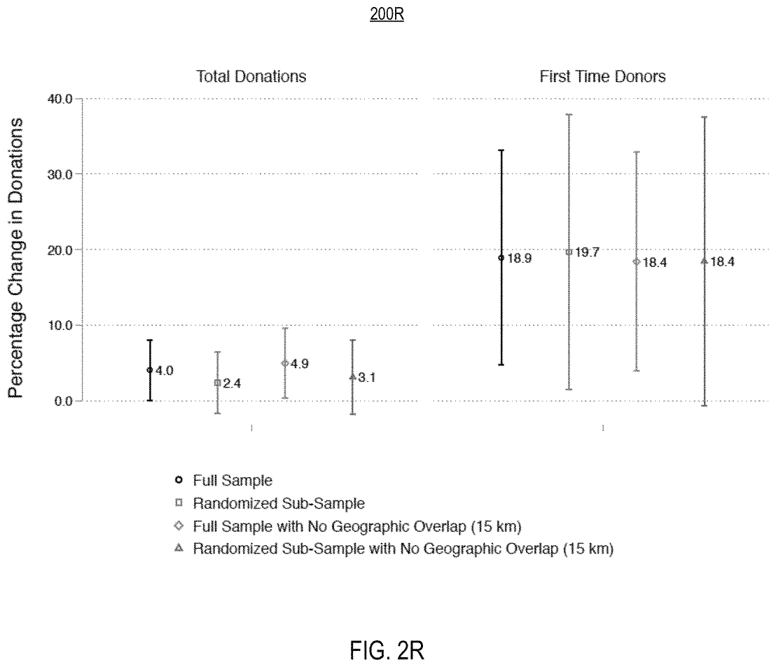

FIGS. 2A-2B illustrate graphs 200A-200B illustrating change in donations when using a blood donation tool, according to an example. A social media platform may initiate a number of efforts to encourage public health improving behaviors, such as World Health Organization (WHO) recommended behaviors to decrease the spread of disease, preventive health measures, seasonal flu vaccine uptake, and blood donation. In the near future, social media may play a role in important efforts such as encouraging the uptake of a vaccine or other preventative measure. However, despite these important ongoing efforts and future possibilities, very little causal evidence exists of the impact of these efforts on desired offline behaviors. Given its global scale, how well social media platforms are able to encourage one prosocial behavior may be important for one well-functioning area of health systems: blood donation.

Blood donation is a particularly difficult, yet essential prosocial behavior that is often critically undersupplied. Donating blood typically requires individuals to overcome a set of physical and logistic challenges (e.g., obtain transportation, allocate sufficient time for the procedure and recovery, and the physical and psychological discomfort associated with the procedure) to complete an act for which they often have no tangible evidence of benefit to others. There is also generally no substitute for blood. Blood cannot be manufactured and may have a limited shelf life. Blood is required, among other things, for surgery, cancer treatment, burn and accident victims, genetic blood disorders, and complications during childbirth. Without a system based on voluntary unpaid blood donations, no country can provide sufficient blood for all patients who require transfusion. In the developing world, countries often lack voluntary donations. For these reasons increasing voluntary donations, especially from first time blood donors, is critical to securing sufficient and sustainable blood supply.

The systems and methods described here provide a blood donation tool with the aims of connecting people to the cause of blood donation, lowering information costs to help individuals identify opportunities (and criteria) to donate, and encouraging donors to take action.

FIGS. 2C-2E illustrate screens 200C-200E of a blood donation tool via a user device, according to an example. As describe above, the blood donation tool described herein may be used for at least three key intervention components. The first may be a largescale, targeted awareness campaign that connected people to the cause of blood donation. This may include serving invitations in peoples' social media news feeds, posts, or updates. The invitation may highlight the benefits of donating blood to others, as shown in FIG. 2C. Interested people could select to opt-in to receive more information about opportunities to donate near them (e.g., within a 15 km radius of their location). Users who elect to opt-in may provide various information (e.g., user information) to a local partner or a global partner, and may be informed that information about them may or may not be shared with blood banks. Instead, they may elect to receive subsequent invitations about opportunities to donate to local blood banks through the social media platform. This large-scale awareness campaign may work to help build a large pool of interested individuals within each country or geographic region.

The second intervention component may involve an approach to lower information costs. Blood banks that sign up for the blood donation tool may elect to send alerts to opted-in individuals located within 15 km (or other radius) of their facility every 14 days (or other predetermined time period) through manual or automated alerts. These alerts may be triggered by the local blood donation facility or other entity, or service by a social media platform. Information highlighted in these alerts may include, but not limited to, the following: showing the location of the nearest blood bank; indicating what blood type(s) the local bank was recruiting for; providing logistical information like the blood donation center's hours, address, and telephone number; and offering clear guidance on donation eligibility, as shown in FIG. 2D. In some examples, users (e.g., from a pool of volunteer donors) may be enabled to opt-in to receive information related to opportunities to donate as well.

The third intervention component may provide any number of ways for blood banks (or other partners) to inspire donors and for donors to inspire each other. Feedback published from blood banks and blood donors to a social media outlet may indicate that it is important for the blood donation tool to include inspirational pictures or language such as donation stories or stories about the impact of how a donation is or can be used by a medical patient when recruiting donors. The systems and methods described herein may also suggest that allowing donors to invite their social media friends or connections to donate or share their donation stories with friends can be something that often occurred offline and that allowing donors to share with online friends and/or family would help inspire donation behavior. Therefore, the blood donation tool provided by the systems described herein may allow, among other things, blood banks to include inspirational language in their requests and offered ways for donors to inspire each other, as shown in FIG. 2E.

It should be appreciated that there may not be any direct financial costs or fees associated with using the blood donation tool for donors or blood banks. The only related cost for blood banks may be that of the blood bank's time, which in many cases can be very minimal, especially when using automatic alerts to donors. If blood banks chose manual rather than automated alerts, additional time may be required.

FIG. 2F illustrates a diagram 200F of blood donation partners from a geographic area, according to an example. In the United States, for example, partnership with four of the largest blood donation organizations (e.g., American Red Cross, Vitalant, Versiti, and New York Blood Centers) may be made, and such partnerships may facilitate tracking of daily blood donation visits before and after the roll-out of the blood donation tool. In some preliminary experimental finds, these four organizations represent 43.6% of the active community (non-hospital) blood banks and collection facilities collecting whole blood in the contiguous United States. These organizations also have broad geographic coverage including facilities in 46 states and Washington, D.C., as shown in FIG. 2F. In this example, the blood donation tool was rolled out to fixed location collection facilities and studies with regard to facilities that are regularly staffed and offer the opportunity to donate blood daily were made. Mobile blood drives may also an important part of the U.S. blood supply. However, focus on fixed location facilities was made since the blood donation tool was launched in a limited fashion with these facilities during the three-month study period. It should be appreciated that these represent just the preliminary findings. Other various examples or scenarios may also be contemplated or provided.

FIGS. 2G-2J illustrate graphs 200G-200J illustrating average daily donations, according to an example. For example, based on experimental implementation of the systems and methods described herein, the blood donation tool increased total donations by 4.0% [95% CI: 0.04% to 8.0%] and increased donations from first-time donors by 18.9% [95% CI: 4.7% to 33.1%] during the staggered product rollout. We interpret these results as causal because of parallel pre-trends prior to the introduction of the tool, as shown in FIGS. 2G-2J.

FIG. 2K illustrates a graph 200K illustrating placebo tests examining parallel pre-trends, according to an example. It should be appreciated that the series of placebo tests, as shown, may also be provided. For instance, a randomized controlled trial (RCT) subsample (excluding more than 9,000 observations from the 59 blood donation facilities in five non-randomly selected pilot locations) were examined, and among this sub-sample, the blood donation tool increased overall donations 2.4% [95% CI: −1.7% to 6.5%] and increased donations from first time donors 19.7% [95% CI: 1.5% to 37.9%]. Because the data would overstate effects if the blood donation tool pulled blood donors away from nearby non-study facilities (i.e., from facilities other than the American Red Cross, Vitalant, Versiti, and New York Blood Centers), and examination of the sub-sample of study facilities with no possible geographic overlap with non-study facilities (at least 15 km away from a non-study facility; see a larger discussion about multiple types of potential spillovers in the supplementary materials). Such findings revealed that the blood donation tool increased overall donations 4.9% [95% CI: 0.35% to 9.5%] and increased donations from first time donors 18.4% [95% CI: 3.9% to 32.9%] (Fig. S16, Table S6). Analyzing the RCT sub-sample that had no geographic overlap with non-study facilities resulted in findings that the blood donation tool increased overall donations 3.1% [95% CI: −1.8% to 8.0%] and increased donations from first time donors 18.4% [95% CI: −0.7% to 37.5%].

FIGS. 2L-2P illustrates diagrams and graphs of a blood donation partners from two geographic areas, according to an example. The systems and methods described herein may use a different evaluation strategy in other geographic locations, such as Brazil and/or India. The social media platform employing the blood donation tool in this way required contracting with external data-collection teams and placing them at partner blood collection facilities, as shown in diagrams 200L-200M of FIGS. 2L-2M. These data-collection teams were present at each facility for two or three waves of 30 consecutive days staggered throughout the first year after each facility started using the blood donation tool. In total, this sample includes approximately 1,900 observation-days across 35 facilities in Brazil and approximately 600 observation-days across 34 facilities in India.

Enumerators asked individuals who arrived at the collection facility whether a social network influenced their decision to come to donate blood. Enumerators also asked respondents whether they would consent to share their Facebook identification and permit a social network to check whether the blood donation tool had sent them notifications.

By construction, this measure was 0% when the tool was rolled out. This rate rose about one percentage point per month, so by the end of the first year 14.1% [95% CI: 12.1% to 16.2%] of donors had social media-related visits. Additionally, each of these measures on their own also showed steadily increasing attribution rates over the first year of deployment, as shown in graphs 200N-200P of FIGS. 2N-2P.

These results are distinctive from past studies to increase blood donation rates. First, evidence is provided with regard to blood donation interventions outside of Western Europe, North America, and Australia, which are the typical geographic focuses of the academic blood donation literature. The geographic breadth of this study may also be larger than existing impact evaluations examining interventions to encourage blood donation. While most past studies are sub-national, this study covers blood donation centers across the United States, Brazil, and India.

Second, this study demonstrates a way to increase blood donation without providing economic incentives to donors. The standing WHO guidance is that countries should obtain blood only from unpaid volunteers. However, there are substantive arguments that the WHO should consider broadening these restrictions. For example, numerous well-identified microeconomic studies show increases in blood donations due to some type of economic incentives. The studies shown herein reveals meaningful increases in blood donations while not conflicting with WHO guidance and therefore may be more politically and administratively feasible to implement in many countries and contexts.

Third, the blood donation tool appeared to have reached an important audience of new and younger donors. Demographic shifts, especially in developed countries, imply increased medical demand for blood as populations age, while at the same time these populations will have fewer young people from which to supply blood. Social media users in general skew younger than the population as a whole. The median age of those that signed up for the blood donation tool in the United States was 33.0 years old while the median age of the U.S population is 38.3 years old. This blood donation tool, then, may be suited to drive new (most likely younger) donors as populations continue to age.

Lastly, the potential scale and impact of these interventions, as well as any other tools developed on the social media platform, may provide global reach. To give a sense of the order of magnitude of potential longer term impact, consider that during the three-month study period, approximately 390,000 social media users signed up for the blood donation tool in the U.S., and only roughly half were eligible to use the tool (by being in treated states). From these approximately 195,000 individuals in treated, a 4.0% and 18.9% increase in blood donations were observed among all and new donors, respectively. If we assumed proportional increase of rates of donation among the additional people who signed up, there would be an expectation of at least ten times, or a 40% increase in overall blood donations and a 189% increase in donations from new donors. Even if we assumed a quarter of that rate, it would still imply a 10% and 47% increase in donations from all and new donors, respectively.

Furthermore, these new donors are especially valuable for the ongoing sustainability of the blood supply. A recent study found that 45% of first-time blood donors returned to donate blood an average of 3.09 times per donor over a two-year window after the initial donation suggesting that the growth in new donors observed in our study could drive future growth in the blood supply. While it is acknowledged that this exercise to predict the longer-term effects of the tool cannot be guaranteed, it nevertheless suggests that that the impact of the blood donation tool may be larger than what can be expected from any three-month study.

Despite limitations in any such studies, it should be appreciated that these initial preliminary findings lend substantial support to the hypothesis that social media platforms can play a meaningful role in fostering offline prosocial behaviors. To maximize the impact social media platforms can have on societal needs such as those in public health, rigorous testing of many potential interventions may be needed to identify how to most effectively encourage desired behaviors. This may be especially important in the coming months and years as society addresses difficult challenges that will require coordinated behavior, such as climate change or virus-related incidents. When designed and implemented through thoughtful partnerships, these tools may offer a powerful means to connect billions of people to take positive actions for the health and well-being of societies around the world.

FIG. 2Q illustrates a diagram 200Q of a blood donation partners from two geographic areas with non-overlapping or overlapping radii, according to an example. The F.D.A database gives the zip code (but not the exact address) of all licensed sites. Therefore, the systems and methods the exact addresses of the 363 facilities from our four partner organizations (American Red Cross, New York Blood Centers, Versiti, and Vitalant) along with the zip codes of each of the 469 collection facilities not included in our study. Because the blood donation tool only sent messages to users within 15 km of a facility, we drew a circle with a 15 km radius around each of the 363 partner facilities and examined if these circles intersected with the zip codes of non-study collection facilities, as shown in FIG. 2Q. In total, 24.8% (90/363) of the study sites intersected with the zip code of a non-study collection facility, however, only 12.1% (44/363) of these were in the treatment group.

FIG. 2R illustrates a graph 200R illustrating change in donations when using a blood donation tool, according to an example. We reran our main regression on the sample of sites that did not overlap with the zip codes of non-study collection facilities (Table S6). If the size of the coefficient for the sample with no geographic overlap shrunk and/or lost statistical significance, this would suggest that the results were being driven by the facilities with geographic overlap. The coefficient for all donations and donations from the first time donors for the full sample was 0.55 and 0.15 (col. 1 and col. 2, Table S3). In the sub-sample with no geographic overlap, we find a larger (0.67) and still statistically significant coefficient for all donations (col. 1, Table S6) and a similarly sized (0.14) and still statistically significant coefficient for donations by first time donors (col. 2, Table S6). We also did this with the smaller RCT sub-sample. The coefficient for all donations and donations from the first time donors for the RCT sub-sample was 0.32 and 0.15 (col. 3 and col. 4, Table S3). In the RCT sub-sample with no geographic overlap, we find a larger coefficient, 0.42, for all donations (col. 3, Table S6) and a same sized coefficient, 0.15, for donations by first time donors (col. 4, Table S6). The coefficients are presented graphically as percentages in FIG. 2R.

By using the map tile approach in this way, the systems and methods described herein may obviate the problems associated with selecting a fixed radius and adjusting (increased or decreased) as many conventional systems do. Because the initial search radius is calculated based on item density, delays due to the inexact starting point or to the number of iterations it may take to get to the appropriate or desired count for search results may be reduced or eliminated.

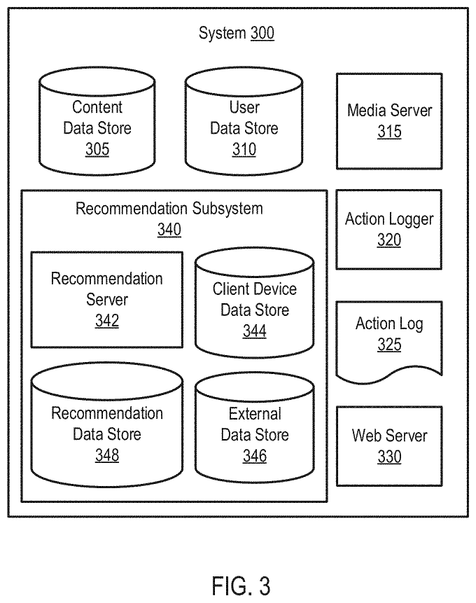

FIG. 3 illustrates a block diagram of a system 300 for providing AI-based recommendations, according to an example. It should be appreciated that the system 300 may be similar to the system 100 as described with respect with FIG. 1, but the system 300 may be described with more specificity and/or with examples of additional capabilities and features that may or may not be a part of system 100. In some examples, the system 300 may be an online system (e.g., a social media system) having a recommendation subsystem 340 to help provide search features as well as provide item recommendations for any number of client devices 110 communicatively coupled to the system 300 via the network 120. As shown, the system 300 may include a content data store 305, a user data store 310, a media server 315, an action logger 320, an action log 325, and a web server 330.

The content data store 305 may store a variety of content associated with a search query for an item within a search area, as described herein. As a result, the content data store 305 may involve any digital content associated with searching an item, mapping a geography, etc. For example, such content may include digital content media associated with any number of items, such as events, directions, and/or other goods or services to be searched or recommended.

The user data store 310 may also store, among other things, data associated with users. This data may include user profile information directly provided by a user or inferred by the system 300. Examples of such information may include biographic, demographic, pictorial, and/or other types of descriptive information, such as employment, education, gender, hobbies, preferences, location, etc. It should be appreciated that any personal information that is acquired may be subject to various privacy settings or regulations, as described below.

The media server 315 may be used, among other things, to gather, distribute, deliver, and/or provision various digital media content, e.g., stored in the content data store 305 or elsewhere. The media server 315 may be used by system 300 to coordinate with the external system 130 of FIG. 1B, for example, which to facilitate processing of any search query or provide recommendations to any number of client devices 110.

The system 300 may also include an action logger 320, an action log 325, and a web server 330. In some examples, the action logger 320 may receive communications about user actions performed on or off the system 100, and may populate the action log 325 with information about various user actions. Such user actions may include, for example, adding a connection to another user or entity, sending a message from another user or entity, viewing content associated with another user or entity (such as another user or an advertisement), initiating a payment transaction, etc. In some examples, the action logger 320 may receive, subject to one or more privacy settings or rules, content interaction activities associated with another user or entity. In addition, a number of actions described in connection with other objects may be directed at particular users, so these actions may be associated those users as well. Any or all of these user actions may be stored in the action log 325.

The system 100 may use the action log 325 to track user actions on the system 100 or other external systems. The action log 325 may also include context information associated with context of user actions. For example, such content information may include date/time an action is performed, other actions logged around the similar date/time period, or other associated actions. Other context information may include user action patterns, patterns exhibited by other similar users, or even various interactions a user may have with any particular or similar object. These and other similar actions or other similar information may be stored at the action log 325, and may be used for calculating a search radius based on density using map tiles and/or providing recommendations using the search radius, as described herein.

The web server 330 may link the system 300 via a network (e.g., network 120 of FIG. 1B) to one or more client devices (e.g., client devices 110 of FIG. 1B). The web server 330 may serve web pages, as well as other web-related content, such as Java, Flash, XML, or other similar content. The web server 330 may communicate with various internal elements of the system 300 or external network components to provide various functionalities, such as receiving, transmitting, and/or routing content between the system 300, client devices, and other network elements or components.

As described herein, the system 300 may also include the recommendation subsystem 340. The recommendation subsystem 340 may employ one or more techniques to help define, modify, track, schedule, execute, compare, analyze, evaluate, and/or deploy one or more applications for the system 300. In some examples, the recommendation subsystem 340 may also employ any variety of techniques to provide item recommendations, for instance, using information from client devices 110, external system 130, or other network elements (not shown) of the system environment 150. In some examples, the recommendation subsystem 340 may include a recommendation server 342, a client device data store 344, a host system data store 346, and a recommendation data store 348.

In particular, the recommendation server 342 of the recommendation subsystem 340 may enable the system 300 to provide any number of item recommendations to client devices 110, as discussed herein. Specifically, the recommendation server 342 may, in some examples, analyze, evaluate, examine, and/or update data associated with any search for an item in or near any search area. Based on these assessments, the recommendation server 342 may identify and/or recommend various items for the client devices 110, where these items may include, but not limited to, events, such as musical events, art events, culinary events, etc.

The recommendation subsystem 340 may use the client device data store 344 to store content associated with client devices 110, and the recommendation data store 348 to store content associated with data and/or any information derived from such any search query or other relevant data, such as recommendation data, historical data, etc.

Although not depicted, it should be appreciated that system 300 may also include various artificial intelligence (AI) based machine learning tools to help provide item recommendations. For example, these AI-based machine learning tools may be based on optimization of different types of content analysis models, including but not limited to, algorithms that analyze data and potential search results, and other details to provide relevant item recommendations. For instance, these AI-based machine learning tools may be used to generate models and/or classifiers that may include a neural network, a tree-based model, a Bayesian network, a support vector, clustering, a kernel method, a spline, a knowledge graph, or an ensemble of one or more of these and other techniques. These AI-based machine learning tools may further generate a classifier that may use such techniques. The recommendation subsystem 340 may periodically update the model and/or classifier based on additional training or updated data associated with the system 300. It should be appreciated that the recommendation subsystem 340 may vary depending on the type of input and output requirements and/or the type of task or problem intended to be solved. The recommendation subsystem 340, as described herein, may use supervised learning, semi-supervised, and/or unsupervised learning to build the model using data in the training data store. Supervised learning may include classification and/or regression, and semi-supervised learning may require iterative optimization using objection functions to fill in gaps when at least some of the outputs are missing. It should also be appreciated that the recommendation subsystem 340 may provide other types of machine learning approaches, such as reinforcement learning, feature learning, anomaly detection, etc.

In some examples, the system 300 may provide a manual mode of operation, where a user may narrow down selection with limited or without use of the recommendation subsystem 340. For instance, the user may search for items by a sorting feature, as follows: Content Type >Category >Sort by Name >Sort Items Within 100-Mile Radius >Sort by Reviews. In some examples, the system 300 may provide a search feature that may use natural language processing (NLP) or other similar search function to accept user search inputs. In this way, a user may be presented with a list of item recommendations, but may use the search feature to refine his or her search. For example, as the user types his or her desired event, etc., the list of recommendations may be continuously and/or automatically refined based on the user's input. For example, if the user enters “S” into the search feature, the recommendation subsystem 340 may narrow the list of recommendations to those events that begin with the letter “S.” If the user continues typing the user search input and enters “Swing” into the search feature, the recommendation subsystem 340 may narrow the list of recommendation to ones that begin or have the word “Swing.” Other various similar or different features may also be provided.

It should be appreciated that classification algorithms may provide assignment of instances to pre-defined classes to decide whether there are matches or correlations. Alternatively, clustering schemes or techniques may use groupings of related data points without labels. Use of knowledge graphs may also provide an organized graph that ties nodes and edges, where a node may be related to semantic concepts, such as persons, objects, entities, events, etc., and an edge may be defined by relations between nodes based on semantics. It should be appreciated that, as described herein, the term “node” may be used interchangeably with “entity,” and “edge” with “relation.” Also, techniques that involve simulation models and/or decision trees may provide a detailed and flexible approach to providing item recommendations associated with calculating a search radius based on density, as described herein.

It should be appreciated that the systems and subsystems, as described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the processors, systems, subsystems, and/or other computing devices may be shown as single components or elements (e.g., servers), one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100 and/or 300.

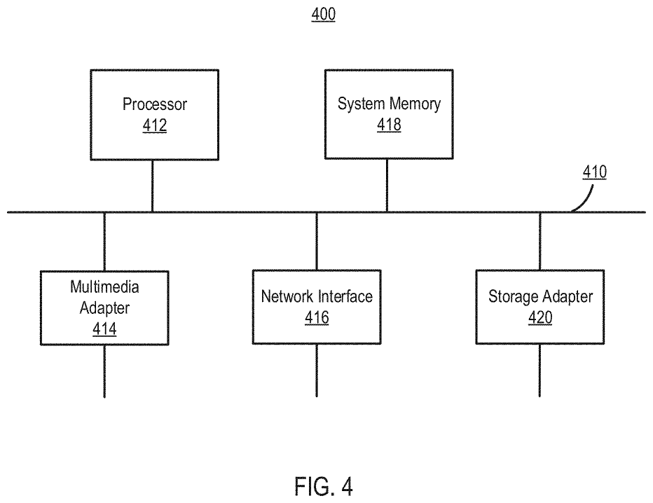

FIG. 4 illustrates a block diagram of a computer system 400 for providing recommendations using a search radius based on density, according to an example. The computer system 400 may be part of or any one of the client devices 110, the external system 130, the host systems 140, and/or the system 100 and/or 300 to perform the functions and features described herein. The computer system 400 may include, among other things, an interconnect 510, a processor 412, a multimedia adapter 414, a network interface 416, a system memory 418, and a storage adapter 420.

The interconnect 410 may interconnect various subsystems, elements, and/or components of the computer system 400. As shown, the interconnect 410 may be an abstraction that may represent any one or more separate physical buses, point-to-point connections, or both, connected by appropriate bridges, adapters, or controllers. In some examples, the interconnect 410 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 410 may allow data communication between the processor 412 and system memory 418, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 412 may be the central processing unit (CPU) of the computing device and may control overall operation of the computing device. In some examples, the processor 412 may accomplish this by executing software or firmware stored in system memory 418 or other data via the storage adapter 420. The processor 412 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 414 may connect to various multimedia elements or peripherals. These may include a devices associated with visual (e.g., video card or display), audio (e.g., sound card or speakers), and/or various input/output interfaces (e.g., mouse, keyboard, touchscreen).

The network interface 416 may provide the computing device with an ability to communicate with a variety of remove devices over a network (e.g., network 120 of FIG. 1) and may include, for example, an Ethernet adapter, a Fibre Channel adapter, and/or other wired- or wireless-enabled adapter. The network interface 416 may provide a direct or indirect connection from one network element to another, and facilitate communication and between various network elements.

The storage adapter 420 may connect to a standard computer-readable medium for storage and/or retrieval of information, such as a fixed disk drive (internal or external).

Many other devices, components, elements, or subsystems (not shown) may be connected in a similar manner to the interconnect 410 or via a network (e.g., network 120 of FIG. 1B). Conversely, all of the devices shown in FIG. 4 need not be present to practice the present disclosure. The devices and subsystems can be interconnected in different ways from that shown in FIG. 4. Code to implement the dynamic approaches for payment gateway selection and payment transaction processing of the present disclosure may be stored in computer-readable storage media such as one or more of system memory 418 or other storage. Code to implement the dynamic approaches for payment gateway selection and payment transaction processing of the present disclosure may also be received via one or more interfaces and stored in memory. The operating system provided on computer system 400 may be MS-DOS®, MS-WINDOWS®, OS/2®, OS X®, IOS®, ANDROID®, UNIX®, Linux®, or another operating system.

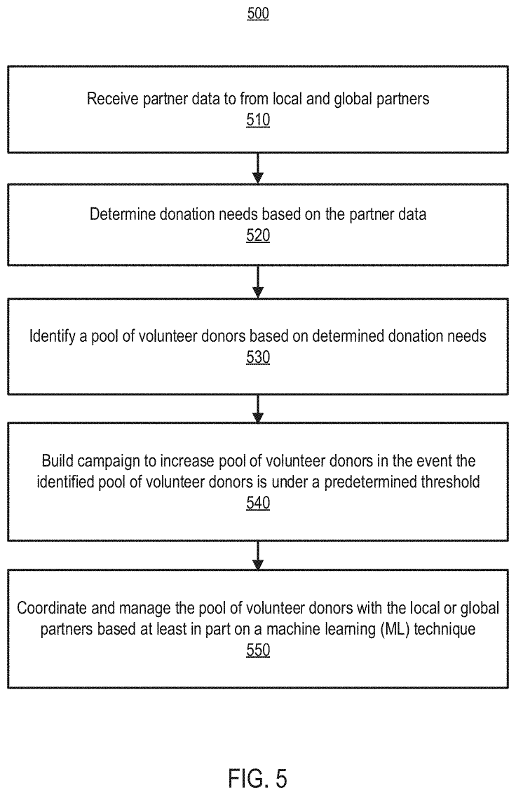

FIG. 5 illustrates a method 500 for coordinating and managing voluntary blood donors with local and global partners, according to an example. The method 500 is provided by way of example, as there may be a variety of ways to carry out the method described herein. Although the method 600 is primarily described as being performed by system 100 as shown in FIG. 1, system 300 of FIG. 3, or computer system 400 of FIG. 4, the method 500 may be executed or otherwise performed by other systems, or a combination of systems. Each block shown in FIG. 5 may further represent one or more processes, methods, or subroutines, and one or more of the blocks may include machine-readable instructions stored on a non-transitory computer-readable medium and executed by a processor or other type of processing circuit to perform one or more operations described herein.

At 510, the system 100 may, via the processor 101, receive partner data from local and/or global partners, e.g., blood banks or other entities to partner with voluntary donors. For example, local and/or global partners that sign up for blood donation may provide an address, a type of blood the local and/or global partner may be recruiting for, and offering clear guidance on donation eligibility.

At 520, the system 100 may, via the processor 101, determine a donation need based on the partner data. For example, in some instances, the system 100 may determine a donation need based on, among other things, a type of blood needed and an (i.e., projected) amount of blood needed.

At 530, the system 100 may, via the processor 101, identify a pool of volunteer donors based on determined donation needs. For example, in some instances, the system 100 may determine a pool of volunteer donors based on, among other things, a type of blood that a user may have and a distance that a user may have to travel to a nearest donation center.

At 540, the system 100 may, via the processor 101, build campaign to increase pool of volunteer donors in the event the identified pool of volunteer donors is under a predetermined threshold. In some examples, this may include serving invitations in peoples' social media news feeds, posts, or updates.

At 550, the system 100 may, via the processor 101, coordinate and manage the pool of volunteer donors with the local or global partners based at least in part on a machine learning (ML) technique. In some examples, to coordinate and manage potential voluntary blood donors from the voluntary blood donor pool with local or global partners, the processor 101 may use at least one machine learning (ML) technique. In some examples, the machine learning (ML) technique may rely at any number of data inputs, such as partner data, user data, and use various ranking and/or weighting calculations to connect potential donors with partners in order to satisfy partner needs and/or improve prosocial behavior.

It should be appreciated that the method 500 may include a variety of other actions. These may include, among other things, identifying users and/or partners within a radius determined from location data, partner data, ranking analysis, user preferences, and/or other data. In some examples, one or more weighting and ranking factors may be calculated from at least one of time, location, distance, category, user preference, user history, associated users, ratings, or trends.

By providing a way to coordinate and manage potential donors with partners as described herein, the systems and methods described herein may provide improved load balancing of network components, maximize utilization of resources, increase speed of processing, and minimize energy consumption. Furthermore, prosocial behaviors may be increased. As a result, it should be appreciated that examples described herein may have a flexible structure and offer many advantages over other solutions.

Although the methods and systems as described herein may be directed mainly to blood donations, it should be appreciated that the system 100 may be used for other types of content or scenarios. Furthermore, the system 100 may also use the techniques disclosed herein in other various environments, such as in load balancing systems, distributed architecture schemes, or for various digital content processing or transactions, such as advertisement transactions, payment transactions, online transactions, mobile transactions, user-to-user transactions, toll-based transactions, and/or digital transactions. Other applications or uses of the system 100 may also include social networking, competitive, marketing, performance analysis, risk analysis, data management, content-based recommendation engines, and/or other types of knowledge or data-driven systems.

It should be noted that the functionality described herein may be subject to one or more privacy policies, described below, enforced by the system 100 that may bar use of images for concept detection, recommendation, generation, and analysis.

In particular examples, one or more objects (e.g., content or other types of objects) of a computing system may be associated with one or more privacy settings. The one or more objects may be stored on or otherwise associated with any suitable computing system or application, such as, for example, the system 100, the client devices 110, the host systems 140, the external system 130, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt-in to or opt out of having their content, information, or actions stored/logged by the system 100 or shared with other systems (e.g., an external system 130). Although this disclosure describes using particular privacy settings in a particular manner, this disclosure contemplates using any suitable privacy settings in any suitable manner.

In particular examples, the system 100 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics. As an example and not by way of limitation, a first user may specify that other users who attend the same university as the first user may view the first user's pictures, but that other users who are family members of the first user may not view those same pictures.

In particular examples, the system 100 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt-in or opt out of having objects or information accessed, stored, or used by specific applications or processes. The system 100 may access such information in order to provide a particular function or service to the first user, without the system 100 having access to that information for any other purposes. Before accessing, storing, or using such objects or information, the system 100 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100.

In particular examples, a user may specify whether particular types of objects or information associated with the first user may be accessed, stored, or used by the system 100. As an example and not by way of limitation, the first user may specify that images sent by the first user through the system 100 may not be stored by the system 100. As another example and not by way of limitation, a first user may specify that messages sent from the first user to a particular second user may not be stored by the system 100. As yet another example and not by way of limitation, a first user may specify that all objects sent via a particular application may be saved by the system 100.

In particular examples, privacy settings may allow a first user to specify whether particular objects or information associated with the first user may be accessed from client devices 110 or external systems 130. The privacy settings may allow the first user to opt-in or opt out of having objects or information accessed from a particular device (e.g., the phone book on a user's smart phone), from a particular application (e.g., a messaging app), or from a particular system (e.g., an email server). The system 100 may provide default privacy settings with respect to each device, system, or application, and/or the first user may be prompted to specify a particular privacy setting for each context. As an example and not by way of limitation, the first user may utilize a location-services feature of the system 100 to provide recommendations for restaurants or other places in proximity to the user. The first user's default privacy settings may specify that the system 100 may use location information provided from one of the client devices 110 of the first user to provide the location-based services, but that the system 100 may not store the location information of the first user or provide it to any external system 130. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt-in or opt out of having mood, emotion, or sentiment information accessed, stored, or used by specific applications or processes. The system 100 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100 may use a user's previous activities and calculated moods, emotions, or sentiments to determine a present mood, emotion, or sentiment. A user who wishes to enable this functionality may indicate in their privacy settings that they opt-in to the system 100 receiving the inputs necessary to determine the mood, emotion, or sentiment. As an example and not by way of limitation, the system 100 may determine that a default privacy setting is to not receive any information necessary for determining mood, emotion, or sentiment until there is an express indication from a user that the system 100 may do so. By contrast, if a user does not opt-in to the system 100 receiving these inputs (or affirmatively opts out of the system 100 receiving these inputs), the system 100 may be prevented from receiving, collecting, logging, or storing these inputs or any information associated with these inputs. In particular examples, the system 100 may use the predicted mood, emotion, or sentiment to provide recommendations or advertisements to the user. In particular examples, if a user desires to make use of this function for specific purposes or applications, additional privacy settings may be specified by the user to opt-in to using the mood, emotion, or sentiment information for the specific purposes or applications. As an example and not by way of limitation, the system 100 may use the user's mood, emotion, or sentiment to provide newsfeed items, pages, friends, or advertisements to a user. The user may specify in their privacy settings that the system 100 may determine the user's mood, emotion, or sentiment. The user may then be asked to provide additional privacy settings to indicate the purposes for which the user's mood, emotion, or sentiment may be used. The user may indicate that the system 100 may use his or her mood, emotion, or sentiment to provide newsfeed content and recommend pages, but not for recommending friends or advertisements. The system 100 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100 may be restricted in its access, storage, or use of the objects or information. The system 100 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100 may temporarily store the message in a content data store until the second user has viewed or downloaded the message, at which point the system 100 may delete the message from the data store. As another example and not by way of limitation, continuing with the prior example, the message may be stored for a specified period of time (e.g., 2 weeks), after which point the system 100 may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100. The user's privacy settings may specify that such information may be used only for particular processes, such as authentication, and further specify that such information may not be shared with any external system 130 or used for other processes or applications associated with the system 100. As another example and not by way of limitation, the system 100 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system 130 or used by other processes or applications associated with the system 100. As another example and not by way of limitation, the system 100 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system 130 or used by other processes or applications associated with the system 100.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the system 100 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100 may send a reminder to the user to confirm his or her privacy settings every six months or after every ten photo posts. In particular examples, privacy settings may also allow users to control access to the objects or information on a per-request basis. As an example and not by way of limitation, the system 100 may notify the user whenever an external system 130 attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, when executed by the processor, cause the processor to:
receive partner data from one or more of a local partner and a global partner;
determine a donation need based on the partner data;
identify a pool of volunteer donors based on the donation need;
build an online campaign to increase the pool of volunteer donors; and
coordinate the pool of volunteer donors with the local or global partners based at least in part on a machine learning (ML) technique.

2. The system of claim 1, wherein the online campaign is built based on the pool of volunteer donors being under a predetermined threshold.

3. The system of claim 1, wherein the donation need is a need for blood donations.

4. The system of claim 3, wherein the instructions, when executed by the processor, cause the processor to:
publish feedback from the local partner or the global partner to the pool of volunteer donors.

5. The system of claim 1, wherein the instructions, when executed by the processor, cause the processor to:
scan a density of users within a location; and
map a location of each of the users within the location to identify the pool of volunteer donors.

6. The system of claim 1, wherein the instructions, when executed by the processor, cause the processor to:
to enable a user from the pool of volunteer donors to opt-in to receive information related to opportunities to donate.

7. The system of claim 6, wherein the instructions, when executed by the processor, cause the processor to:
enable the user to provide user information to the local partner or the global partner.

8. The system of claim 6, wherein the instructions, when executed by the processor, cause the processor to:
enable the local partner or the global partner to provide an alert to the user.

9. The system of claim 6, wherein the alert includes a location of a nearest blood bank, a blood type the nearest blood bank is recruiting for, and guidance on donation eligibility.

10. The system of claim 1, wherein the instructions when executed by the processor further cause the processor to:
provide logistical information related to the donation need, the logistical information including an address and telephone number of a blood donation center.

11. A method for coordinating and managing voluntary blood donors with local and global partners, comprising:
receiving partner data from one or more of a local partner and a global partner;
determining a donation need based on the partner data;
identifying a pool of volunteer donors based on the donation need;
building an online campaign to increase the pool of volunteer donors; and
coordinating the pool of volunteer donors with the local or global partners based at least in part on a machine learning (ML) technique.

12. The method of claim 11, wherein the online campaign is built based on the pool of volunteer donors being under a predetermined threshold.

13. The method of claim 11, wherein the donation need is a need for blood donations.

14. The method of claim 11, further comprising:
publishing feedback from the local partner or the global partner to the pool of volunteer donors.

15. The method of claim 11, further comprising:
enabling a user from the pool of volunteer donors to opt-in to receive to information about opportunities to donate.

16. The method of claim 15, further comprising:
enabling the user to provide user information to the local partner or the global partner.

17. A non-transitory computer-readable storage medium having an executable stored thereon, which when executed instructs a processor to:
receive partner data from one or more of a local partner and a global partner;
determine a donation need based on the partner data;
identify a pool of volunteer donors based on the donation need;
build an online campaign to increase the pool of volunteer donors; and
coordinate the pool of volunteer donors with the local or global partners based at least in part on a machine learning (ML) technique.

18. The non-transitory computer-readable storage medium of claim 17, wherein the online campaign is built based on the pool of volunteer donors being under a predetermined threshold.

19. The non-transitory computer-readable storage medium of claim 17, wherein the donation need is a need for blood donations.

20. The non-transitory computer-readable storage medium of claim 17, wherein the online campaign includes alerts to be sent to opted-in individuals within a predetermined distance.
